(19) United States
(12) Patent Application Publication
(10) Pub. No.: US 2002/0111841 A1
(43) Pub. Date: Aug. 15, 2002

(54) Controlling commands in workflow management systems

(75) Inventors: Frank Leymann, Aidlingen (DE); Dieter Roller, Schoenaich (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/068,370

(22) Filed: Feb. 6, 2002

(30) Foreign Application Priority Data
Feb. 9, 2001 (DE) 01103064.0

(51) Int. Cl. G06F 17/60

(52) U.S. Cl. 705/7

(57) ABSTRACT

A method and system for providing selective command control within a WorkFlow Management System (WFMS). The WFMS includes a model of a business process. The model defines process activities as nodes of an arbitrary graph and control flows as directed edges of the graph. Upon receiving an issued command directed to a process instance of said model, a it is determined whether the current activity is defined in a command sphere. The command sphere is a sub-graph of the arbitrary graph and defines one or more permissible commands (i.e., commands which can safely be executed during the current activity). The issued command is executed only if it is defined as permissible within the relevant command sphere.

### FIELD OF THE INVENTION

The present invention relates to selective command control related to the execution of instances of process models and/or activities within a Work Flow Management System (WFMS).

### BACKGROUND OF THE INVENTION

An area of technology with increasing importance is the domain of Work Flow Management Systems (WFMS). WFMS support the modeling and execution of business processes. Business processes executed within a WFMS environment control which unit of work of a network of units of work will be performed by whom and which resources are needed for this work. The individual units of work might be distributed across a multitude of different computer systems connected by some type of network.

The product “IBM MQSeries Workflow” is a modern, sophisticated, and powerful workflow management system which supports the modeling of business processes as a network of activities. This network of activities, the process model, is constructed as a directed, acyclic, weighted, colored graph. The nodes of the graph represent the activities which are performed. The edges of the graph, the control connectors, describe the potential sequence of execution of the activities. Definition of the process graph is via IBM MQSeries Workflow's Flow Definition Language (FDL) or via a built-in graphical editor. The runtime component of the workflow management system interprets the process graph and distributes the execution of activities to the right person at the right place, e.g. by assigning tasks in the form of work items to one or more work lists associated with the respective person, wherein said work lists and work items are stored as digital data within the workflow management system.

Besides interacting with work items created from an executing process instance, the state of the art technology also supports interaction with a process instance by entering control commands. Examples of such commands are for instance TERMINATE and SUSPEND. Such control commands can be entered at any time during the execution of a business process provided the user who issues the command has the appropriate privileges. Thus, a privileged user can issue a command, such as TERMINATE, at any time. This can have consequences the user didn't intend because the user cannot be aware of all details which are manipulated during the execution of a certain process model. For example, some business processes cannot be properly terminated after they have carried out a particular activity since late termination may jeopardize the integrity of the data being manipulated (for instance, if data has been irreversibly modified, any possibility of a rollback operation ceases to exist). It is evident that a typical user or even a trained administrator may not be able to foresee all consequences of sending a certain control command to a process instance. As a result, giving users the ability to issue any command at any time is not always desirable.

Only members of the team that develops the model of a business process may be knowledgeable enough to know which commands can be executed at which processing stages of the corresponding process model without creating any harm to the overall business result. The team knowledge must somehow be “enabled” to allow a business process to protect itself from the execution of impermissible control commands.

The weakness of the state of the art approach with respect to this problem area becomes even more distinct if one thinks of typical Internet scenarios commonly characterized as C2B (Consumer-to-Business) or B2B (Business-to-Consumer) business processes. For business reasons within such scenarios certain privileges must be assigned to the person that initiates a business process at a company. Without further protection a computer illiterate clerk who initiates a business process could jeopardize the consistency of the overall system by issuing such control commands.

### SUMMARY OF THE INVENTION

The present invention relates to a method and to a system for providing selective command control within a Work Flow Management System (WFMS). It is assumed that the WFMS includes a process model of a business process and the process model defines one or more activities as the nodes of an arbitrary graph with directed edges of the graph defining a potential control flow within said process model. Upon receiving a command directed to an instance of the process model, it is determined if a current activity instance, currently having control within the flow of control through the process instance, falls within a command sphere. The command sphere comprises a sub-graph of the arbitrary graph and defines one or more commands which may or may not be executed if control resides within said commands sphere. The issued command is executed only if it is defined as being a permissible command.

This approach significantly reduces the risk that a user can jeopardize the integrity of the overall business process by issuing inappropriate control commands. For a particular business process, the development team, which has the most thorough understanding of the process details, can define a command sphere which provides a self-protecting mechanism for the underlying business process. This self-protecting mechanism operates selectively as the set of permissible commands change during process execution dependent on the particular activity which currently has control of the process model.

### BRIEF DESCRIPTION OF THE DRAWINGS

FIG. 1 shows an example of a process model represented by a process graph.

FIG. 2 illustrates various states a process instance may occupy while the flow of control is moving through the process graph.

FIG. 3 reflects an example of a process model representing a book order process comprising a single command sphere to enable a user to cancel a certain book order only before the book has been shipped.

FIG. 4 visualizes the details of the specification of this command sphere for the process model of FIG. 3 using the Flow Definition Language of MQSeries Workflow.

### DESCRIPTION OF THE PREFERRED EMBODIMENT

The drawings and specification set forth a preferred embodiment of the invention. Although specific terms are used, the specific terms should not be construed as limiting the scope of the invention. Various modifications and changes may be made thereto without departing from the broader spirit and scope of the invention as set forth in the appended claims.

The present invention can be realized in hardware, software, or a combination of hardware and software. Any kind of computer system or other apparatus adapted for carrying out the methods described herein is suitable. A typical combination of hardware and software could be a general purpose computer system with a computer program that, when being loaded and executed, controls the computer system such that it carries out the methods described herein.

The present invention can also be embedded in a computer program product, which includes code enabling the implementation of the methods described herein and which, when loaded in a computer system, is able to implement these methods.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form.

The current invention is described with reference to IBM's “MQSeries Workflow” workflow management system. Other WFMS could be used. Furthermore the current teaching applies also to any other type of system which offers WFMS functionality not as a separate WFMS but within some other type of system.

The control commands in the following examples assume a certain running process model in which the commands are processed by the WFMS engine. This should not be understood as a limitation on the invention. The current invention can be applied in other scenarios wherein the processing entity for the control commands is not the WFMS engine itself.

The following is a short outline on the basic concepts of a workflow management system based on IBM's “MQSeries Workflow” WFMS. From an enterprise point of view the management of business processes is becoming increasingly important. Business processes (sometimes referred to only as process) control which units of work will be performed at a given time by whom and which resources are required for this work, A WFMS may support both, the modeling of business processes and their execution.

Modeling of a business process as a syntactical unit in a way that is directly supported by a software system is extremely desirable. Moreover, the software system can also work as an interpreter basically treating such a model as input. The model, called a process model or workflow model, can then be instantiated and the individual sequence of work steps depending on the context of the instantiation of the model can be determined. Such a model of a business process can be perceived as a template for a class of similar processes performed within an enterprise. It is a schema describing all possible execution variants of a particular kind of business process. An instance of such a model and its interpretation represents an individual process, i.e. a concrete, context dependent execution of a variant prescribed by the model. A WFMS facilitates the management of business processes. It provides a means to describe models of business processes (buildtime) and it drives business processes based on an associated model (runtime). The meta model of IBM's WFMS MQSeries Workflow, i.e. the syntactical elements provided for describing business process models, and the meaning and interpretation of these syntactical elements, is described next.

A process model is a complete representation of a process, comprising a process diagram and the settings that define the logic behind the components of the diagram. Important components of a MQSeries Workflow process model, some of which are described in greater detail below, are:

Processes

Activities

Blocks

Control Flows

Connectors

Data Containers

Data Structures

Conditions

Programs

Staff

Activities are the fundamental elements of the meta model. An activity represents a business action that is, from a certain perspective, a semantic entity of its own.

A MQSeries Workflow process model consists of the following types of activities.

A program activity, which has a program assigned to perform it, is invoked when the activity is started. In a fully automated workflow, the program performs the activity without human intervention. Otherwise, the user must start the activity by selecting it from a runtime work list. Output from the program can be used in the exit condition for the program activity and for transition conditions to other activities.

A process activity has a (sub-)process assigned to perform it and is invoked when the activity is started. A process activity represents a way to reuse a set of activities that are common to different processes. Output from the process, can be used in the exit condition for the process activity and for transition conditions to other activities.

The flow of control, i.e. the control flow through a running process determines the sequence in which activities are executed. The MQSeries Workflow workflow manager navigates a path through the process that is determined by the evaluation to TRUE of start conditions, exit conditions, and transition conditions.

Connectors provide links between activities in a process model. Using connectors, one defines the sequence of activities and the transmission of data between activities. Since activities might not be executed arbitrarily they are bound together via control connectors. A control connector might be perceived as a directed edge between two activities; the activity at the connector's end point cannot start before the activity at the start point of the connector has finished (successfully). Control connectors model the potential flow of control within a business process model. Default connectors specify where control should flow when the transition condition of no other control connector leaving an activity evaluates to TRUE. Default connectors enable the workflow model to cope with exceptional events. Data connectors specify the flow of data in a workflow model. A data connector originates from an activity or a block, and has an activity or a block as its target. One can specify that output data is to go to one target or to multiple targets. A target can have more than one incoming data connector.

Process definition includes modeling of activities, control connectors between the activities, input/output containers, and data connectors. A process is represented as a directed acyclic graph with the activities defined as nodes and the control/data connectors defined as the edges of the graph. The graph is manipulated via a built-in graphic editor. The data containers are specified as named data structures. These data structures themselves are specified via the DataStructureDefinition facility. Program activities are implemented through programs. The programs are registered via the Program Definition facility. Blocks contain the same constructs as processes, such as activities, control connectors etc. Blocks are however not named and have their own exit conditions. If the exit condition is not met, the block is started again. The block thus implements a Do Until construct. Process activities are implemented as processes. These subprocesses are defined separately as regular, named processes with all the usual properties. Process activities offer great flexibility for process definition. A process can be constructed through permanent refinement of activities into program and process activities (top-down) or out of a set of existing processes (bottom-up).

All programs which implement program activities are defined via the Program Registration Facility. Each program registration includes the name of the program, its location, and the invocation string. The invocation string consists of the program name and the command string passed to the program.

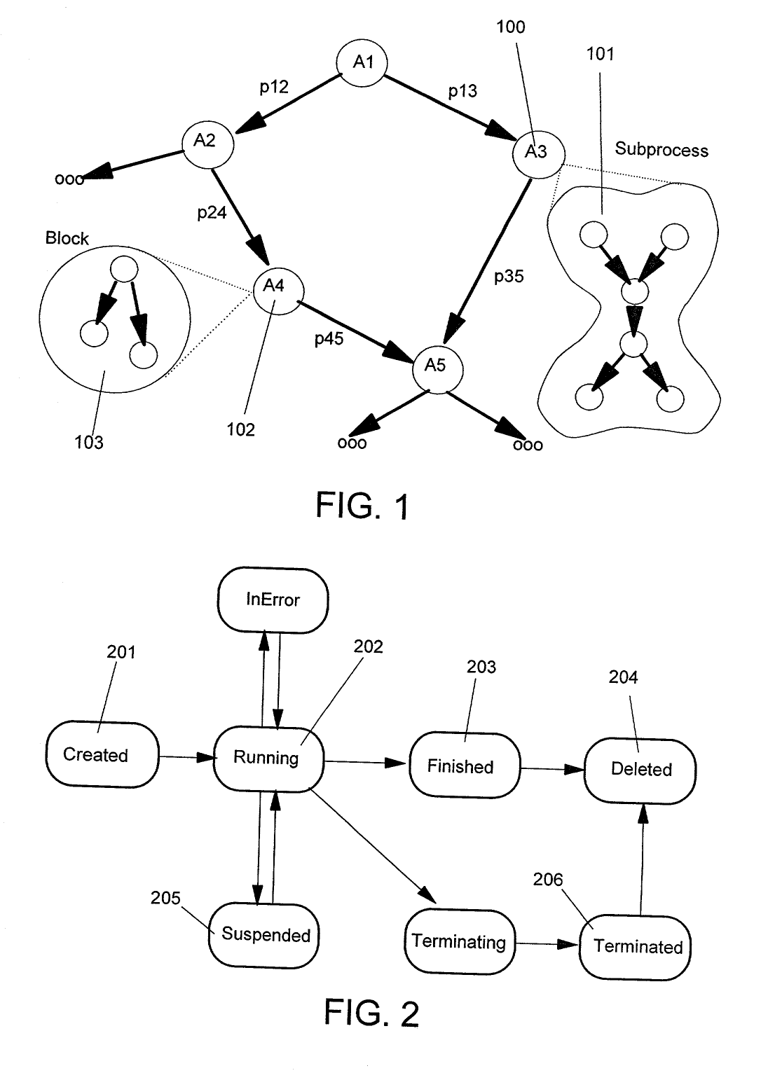

As an example of such a process model, FIG. 1 shows schematically the structure of such a process graph. Activities (A1 up to A5) are represented as named circles with the name typically describing the purpose of the activity. Activities come in various flavors to address the different tasks that may need to be performed and may have different activity implementations to meet these diverse needs. Program activities are performed by an assigned program. Process activities such as activity 100 are performed by another process 101, and blocks such as instance 102 implement a macro 103 with a built-in do-until loop. Control connectors p12, p13, p24, p35, p45 are represented as arrows; the head of the arrow describes the direction in which the flow of control is moving through the process. The activity where the control connector starts is called the source activity; where it ends is called the target activity. When more than one control connector leaves an activity, this indicates potentially parallel work.

In addition to the states a process instance may occupy while the flow of control is moving through the process graph, a process instance can occupy various further states when it is carried out by the workflow management system. FIG. 2 is a simplified illustratation of such states. Workflow management systems typically differentiate among many more states.

A particular business process is created by taking the appropriate process template, possibly populating it with supplied context data, and assigning it a unique process instance identification. This step is usually carried out as the result of invoking the workflow management system's CREATE function. As a result of function completion, the business process is put into the state created 201 creating a process instance from a process model (the template).

When the business process is being carried out, the workflow management system navigates through the process graph and executes the individual activities in Running state 202. The business process is typically put into this state by a client issuing a START control command. Other possibilities are that the business process is automatically started by the workflow management system at a time specified when the business process is created, or a combination of a CREATE and START control command.

When all activities of the business process have been carried out, the process goes into the Finished state 203. No further activities normally occur; however all information about the business process is still available and can, for example, be queried. Some workflow management system still allow operations on a finished business process, such as restarting the business process at the beginning or even in the middle of the business process.

No further actions can be carried out if the business process is in a Deleted state 204. Whether all the business process's information is removed immediately from the workflow management system's store depends on the actual implementation. Some workflow management systems automatically delete the data upon entry into the Deleted state. Others require the invocation of a DELETE function by a corresponding control command.

The Suspended state 205 is entered as the result of entering the SUSPEND function by issuing a corresponding control command. In this state, the workflow management system no longer navigates the business process until requested by a user via a RESUME control command.

A business process enters the Terminated state 206 as the result of the TERMINATE control command, which causes the workflow management system to stop execution of the business process.

As outlined above, the capability to issue any control command directed to a certain process instance at any time is not always desirable.

I is a good idea to “enable” a business process to protect itself from the execution of inappropriate control commands. The knowledge of which control commands can be executed at which stages of a process model without creating any harm to the overall business result typically is available only to the team that developed the process. However, technology allows the team to specify sets of control commands which are permissible for different stages of the business process. An ideal place for storing these specifications is the process model itself.

A concept of command spheres is used in specifying which control commands can be executed at which stages of a certain process model without harming the overall business result. A command sphere identifies a set of activities within a process model and defines permissible and impermissible control commands while any of the activities in the set is controlling the process instance. Where the command sphere identifies a particular control command as being impermissible for a particular activity, a substitute action may be defined to be carried in case the invalid command is entered by the user. In general a command sphere may comprise any sub graph of the process model.

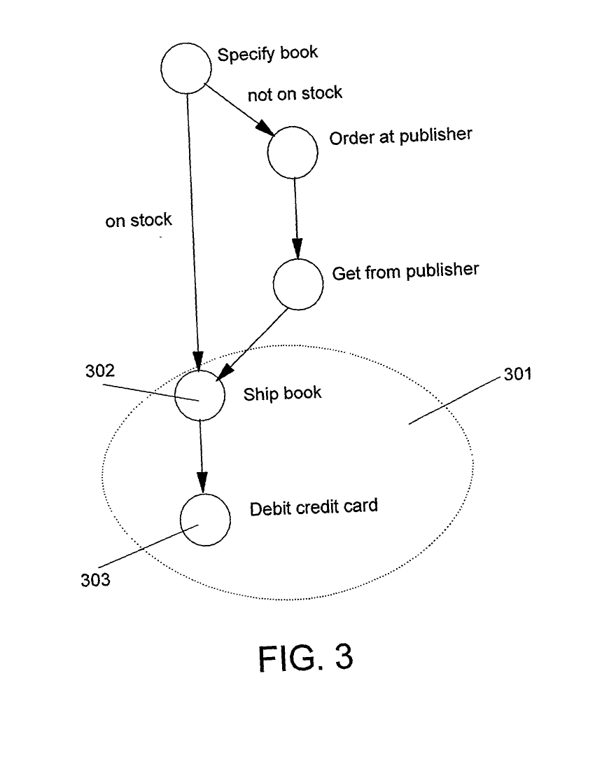

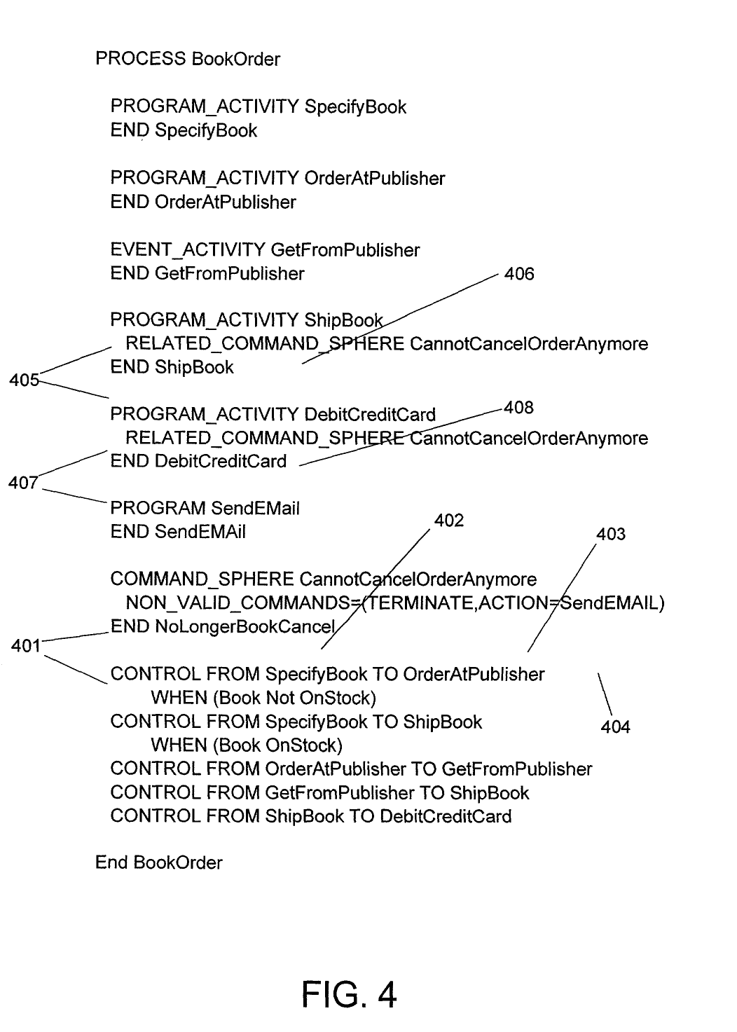

FIG. 3 reflects an example of a process model representing a book order process. To enable a user to cancel a particular book order any time before the book has been shipped (but not in other stages of the execution of the process model) command sphere 301 has been defined. The details of the specification of this command sphere for the process model of FIG. 3 are illustrated using the Flow Definition Language of MQSeries Workflow within FIG. 4.

The command sphere 301 includes the activities “Ship book” 302 and “Debit credit card” 303. Once the flow of control resides in any of these activities of the book order business process, the canceling of the order (expressed by issuing the TERMINATE command) is no longer permitted.

Inspecting the Flow Definition Language in FIG. 4, it can be seen that a new section COMMAND_SPHERE 401 has been added that allows identification of a sub graph in the process model, representing the specification of the command sphere “CannotCancelOrderAnymore”. The keyword NON_VALID_COMMANDS 402 provides for the specification of parameters which identify those commands that are not valid within the command sphere (definition of the non-permissible commands). The ACTION keyword 403 provides, for each of the non-valid commands, the specification of an action that should be carried out if the invalid command is issued by a user. The action could be anything that can be carried out by the workflow management system, such as a program, a process, or even a further command. In the current example the substitute action 404 consists in sending an e-mail.

The identification of those activities which belong to the command sphere takes place within the specification sections of the individual activities. Referring to the example in FIG. 4, the specification section 405 of the activity “Ship book” comprises the RELATED_COMMAND_SPHERE statement 406, which identifies this activity as belonging to the command sphere CannotCancelOrderAnymore 401. Similarly, the specification section 407 of the activity “Debit credit card” comprises the RELATED_COMMAND_SPHERE statement 408, which identifies this activity as belonging to the command sphere CannotCancelOrderAnymore 401.

It should be noted that the complete process model is conceptually a command sphere wherein all commands of the workflow management system are supported.

As a further embodiment of the current invention, methods may be implemented to specify that certain commands are not supported for certain pieces (sub graphs) of the business process. One such method would link the specification of the valid or non-valid commands to individual activities (that is, within the specification sections of the individual activities). Another such method is to attach the valid or non-valid commands to an activity and have that specification valid until overwritten by another specification or by the end of the process. This can be easily transformed into appropriate command sphere specifications as discussed above.

These variants do not deviate from the basic teaching of command spheres as a conceptual approach. These variants are simply based on different approaches relating to the specification techniques of command spheres.

There are almost no limitations to the structure of command spheres. Command spheres may include other command spheres or may even overlap with other command spheres. If a first command sphere is a subset of a second command sphere, this can be interpreted that the permissible commands defined in the first command sphere will override the second permissible commands of the second command sphere. If a first command sphere overlaps a third command sphere when control command is issued, the overlaps may be interpreted as meaning the issued control command should be executed only if it is defined as being permissible in both the first command sphere and the third command sphere.

What is claimed is:

1. A computerized method of providing selective command control within a Workflow Management System (WFMS), said WFMS including a model of a business process, the model defining process activities as the nodes of an arbitrary graph, and process control flows as directed edges of the graph, said method comprising the steps of:
upon receipt an issued command directed to an instance of said process-model, determining whether the activity having current control is defined within a command sphere comprising a sub-graph of said arbitrary graph, and
where the activity having current control is defined with a command-sphere, determining whether the issued command is defined as permissible for the activity having current control; and
executing said issued command, if it is defined in the command sphere as a permissible command.

2. A method according to claim 1 wherein the command sphere further includes definitions of substitute actions and the method comprises the further steps of:
where the issued command is not found to be defined as a permissible command, determining whether a substitute action is defined; and
where a substitute action is defined, executing that substitute action.

3. A method according to either claim 1 or 2 wherein the command sphere is completely included within a second command sphere and said method includes the further step of using the definitions of the included command sphere if a conflict exists between the definitions of permissible actions in the two command spheres.

4. A computerized method of providing selective command control within a WFMS according to claim 2 wherein said command-sphere overlaps a third command-sphere with the activity having current control being defined in both command spheres and wherein the method comprises the further step of executing the issued command only if the command is defined as permissible in both of the command spheres.
